(19) United States
(12) Patent Application Publication
(10) Pub. No.: US 2020/0394676 A1
(43) Pub. Date: Dec. 17, 2020

(54) SYSTEM FOR MANAGING ELECTRONIC COUPONS

(71) Applicant: Marc Weeks, Tallahassee, FL (US)

(72) Inventor: Marc Weeks, Tallahassee, FL (US)

(21) Appl. No.: 16/442,850

(22) Filed: Jun. 17, 2019

(51) Int. Cl. G06Q 30/02; G06F 16/27

(52) U.S. Cl. CPC G06Q 30/0238; G06F 16/27

(57) ABSTRACT

A system for managing electronic coupons is disclosed, comprising a provider in communication with a database to store a plurality of electronic coupons corresponding to a plurality of items. A location module determines a location for one or more consumers utilizing a global positioning system of a computing device. A server transmits one or more of the plurality of electronic coupons from the database to the one or more consumers located within a predefined location selected by the provider.

### TECHNICAL FIELD

The embodiments generally relate to digital services, and more specifically, to networked marketing systems capable of providing access to databases comprising a variety of information related to electronic coupons redeemable at restaurants, grocery stores, and retail outlets.

### BACKGROUND

Marketers spend over $300 billion annually to reach consumers through promotional offers and advertising. Paper-based advertising is known to be highly inefficient, resulting in a higher than necessary cost per redemption for marketers. Customers receive hundreds of coupons in newspapers and catalogs, which must be individually separated and saved before remembering to bring the coupons to the retailer.

In recent years, digital forms of communication have been used as a means of disseminating coupons. Digital coupons increase the convenience of accessing, storing, and redeeming coupons to receive a discount on goods and services. In practice, the coupon is typically received on the consumer's mobile device where it is then stored. The coupon is then presented on the mobile device at the time of purchase to the retailer. Digital coupons often require the consumer to opt-in to an email campaign and sort through emails to retrieve the coupon. While some digital services exist to disseminate the digital coupons, they offer little convenience to the advertiser.

In the food and beverage industries, waste is a natural byproduct of business operations. It is advantageous to minimize waste to increase profit margins, especially for highly perishable items. Managers create promotions, sometimes referred to as “manager specials,” to mitigate losses from waste; however, promotions are difficult to distribute to clientele, even those who are in a similar location as the business.

### SUMMARY OF THE INVENTION

This summary is provided to introduce a variety of concepts in a simplified form that are further disclosed in the detailed description of the embodiments. This summary is not intended to identify key or essential inventive concepts of the claimed subject matter, nor is it intended for determining the scope of the claimed subject matter.

The embodiments described herein relate to a system for managing electronic coupons, the system comprising a provider in communication with a database to store a plurality of electronic coupons corresponding to a plurality of items. A location module determines a location for one or more consumers utilizing a global positioning system of a computing device. A server transmits one or more of the plurality of electronic coupons from the database to the one or more consumers located within a predefined location selected by the provider.

The system for managing electronic coupons provides a means for providers of goods or services, such as restaurant managers, restaurant owners, grocery store managers, food and beverage providers, or similar providers of goods and services to generate and transmit customizable electronic coupons to consumers. Further, the system allows for the provider to customize which consumers will receive the coupons, such as by selecting a geofenced region within which the coupon is distributed.

In one aspect, the system is downloadable as a software service or mobile application on a computing device, such as a smartphone. The system may allow the provider to generate and manage electronic coupons. Further, the system provides the consumer with a means for receiving and redeeming the electronic coupons via their computing device.

In one aspect, each of the plurality of items is associated with one or more product names, a product date, and a product inventory.

In one aspect, the location module permits the provider to select a geofenced region. The location module may then transmit one or more of the plurality of electronic coupons to consumers within the selected geofenced region.

In one aspect, a timing module permits the provider to select a time duration for which the one or more of the plurality of coupons is valid.

In one aspect, the provider selects a discount rate corresponding to the one or more product names.

The system may be utilized to analyze the buying habits of consumers, which may be especially useful for corporate companies operating multiple service locations. Further, the system may be utilized to analyze provider (manager) behavior and assess the success of the providers marketing techniques. In some aspects, the system provides a means for analyzing item success by determining an amount of waste produced by the item.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates an exemplary block diagram of the network infrastructure, according to some embodiments;

FIG. 2 illustrates a block diagram system, according to some embodiments;

FIG. 3 illustrates a list of items provided on the user interface of the provider's computing device, according to some embodiments;

FIG. 4 illustrates a consumer interface and electronic coupon notification, according to some embodiments;

FIG. 5 illustrates an electronic coupon interface, according to some embodiments;

FIG. 6 illustrates a data interface, according to some embodiments; and

FIG. 7 illustrates a block diagram of the server engine and module, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a system for generating, requesting, creating, managing, storing, editing, distributing, and/or auditing electronic coupons. A provider may utilize the system to create a user account and interact with the various functionalities of the system described herein.

As used herein, the term “provider” relates to a user of the system who is creating, managing, generating, editing, and distributing the electronic coupon, which is transmitted electronically to a consumer.

As used herein, the term “administrator” relates to a user of the system who manages the consumer and provider functionalities of the system, such as limiting the amount and discount rate of electronic coupons transmitted to the consumer by the provider. The administrator may also perform general functions used in the arts.

As used herein, the term “consumer” relates to a user of the system who is receiving the electronic coupon from the provider. The consumer may receive electronic coupons from providers with whom they have connected via the network, such as by selecting one or more providers from whom the consumer wishes to receive electronic coupons. In some embodiments, the consumer may “favorite” or “follow” the provider. The consumer may also submit a request, via the network, to the provider to receive electronic coupons.

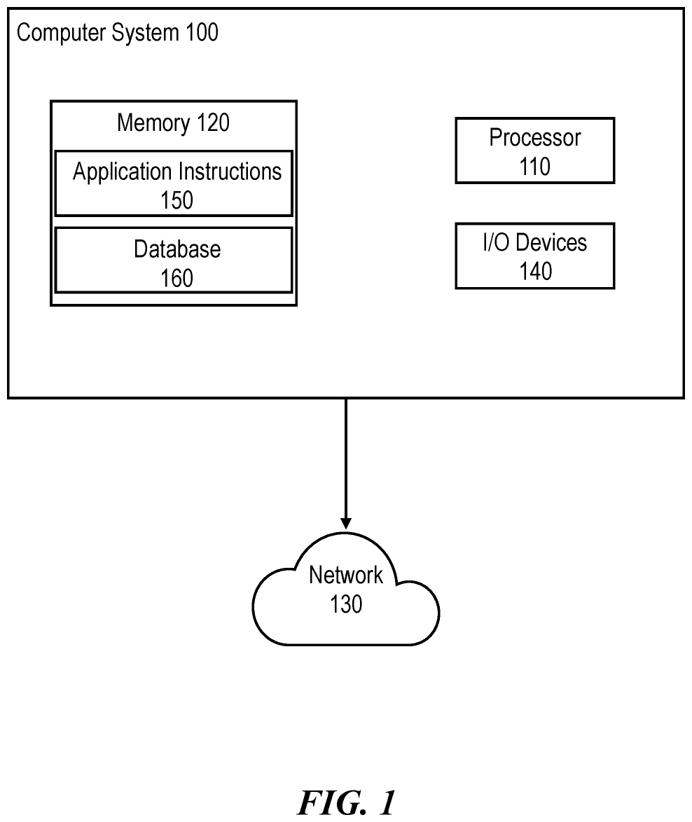

FIG. 1 illustrates a computer system 100, which may be utilized to execute the processes described herein. The computing system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.). The database 160 may include data such as, for example, consumer locations, consumer preferences, consumer parameters (such as favorite providers, favorite locations, favorite items provided by the providers, and similar parameters known in the arts). Further, the database 160 may store data including a plurality of product items (which may include product names, product dates, and product inventories), coupons generated by the provider, data associated with the coupon, provider preferences, and similar data related to the provider.

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

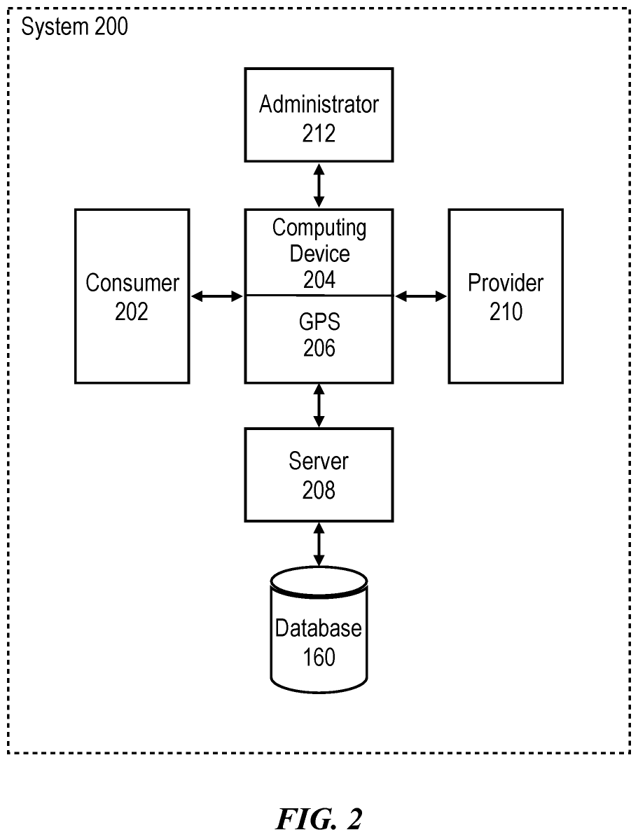

FIG. 2 illustrates an exemplary block diagram of the system 200 which includes a consumer 202 in operable communication with a computing device 204 having a global positioning system (GPS) 206 to transmit location data to the database 160, via server 208. A provider 210 may access the database 160 and consumer 202 information (including the location data) stored thereon to distribute electronic coupons to one or more consumers. An administrator 212 is in communication with database 160 and may establish user preferences, user requirements, product lists, expiration dates of the products contained in the product list, establish electronic coupon rules (such as the limit of coupons which may be transmitted, the limit of discounts associated with the items contained on the product list, the products which may be associated with an electronic coupon, groups of users whom may receive specific electronic coupons, and similar administrative functionalities known in the arts.

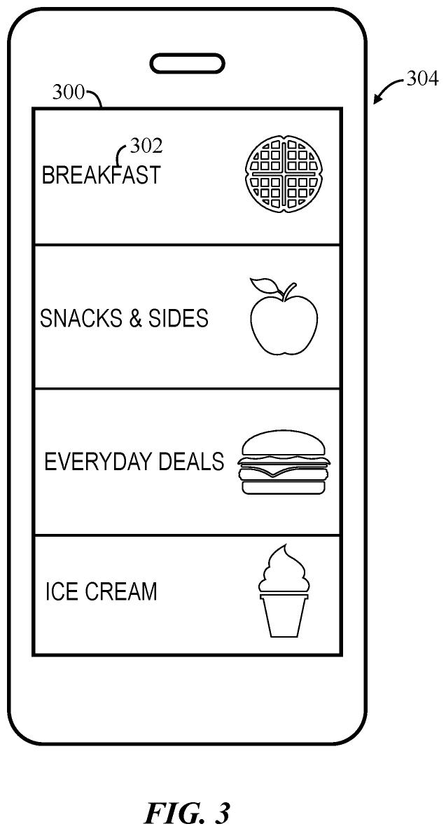

FIG. 3 illustrates a user interface 304, according to some embodiments, wherein the provider may select from a list containing a plurality of items 300, which may be comprised of a plurality of product names or categories 302, product dates (such as expiration dates, best-by dates, packaging dates, shipping dates, or similar dates known in the arts), and product inventories (such as to indicate whether the product is available and in what quantities). Products may further be organized into categories, such as by meal-type. Interface 304 permits the provider to select from the plurality of items 300 and indicate a discount rate, a limit of items which may be discounted, a time during which the coupon is redeemable, and various other parameters known in the arts of coupon management.

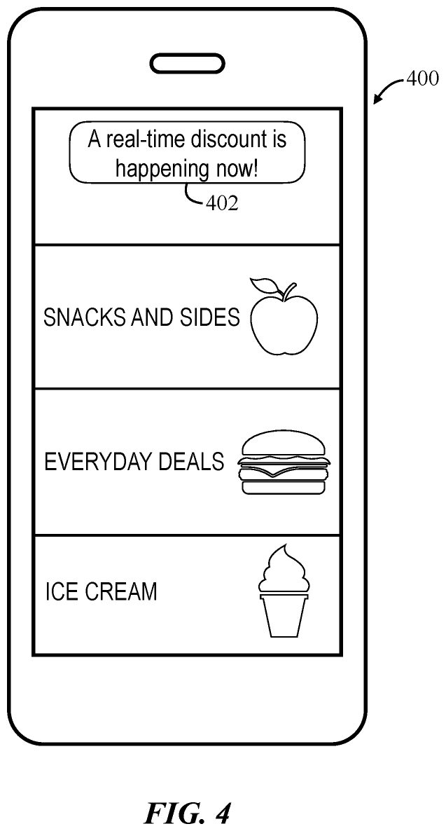

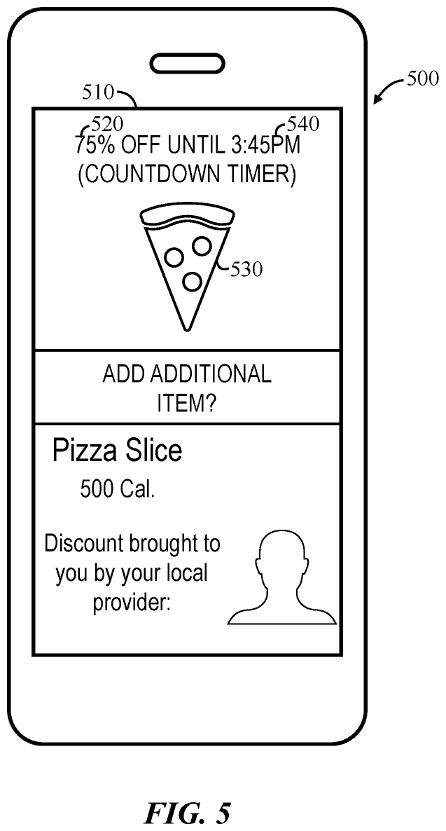

FIG. 4 illustrates the consumer interface 400, wherein a notification 402 is provided. The alert 402 may direct the consumer to an available electronic coupon which has been created by the provider. The notification 402 may be a push-notification to transmit the user to the electronic coupon interface (illustrated in FIG. 5).

FIG. 5 illustrates the electronic coupon interface 500 displayed on the computing device of the consumer. The electronic coupon interface displays the electronic coupon 510, which may include a discount rate 520, an item 530 which has been discounted, provider details, and other item details (such as nutritional facts). The electronic coupon 510 may also display a timer 540, which corresponds to the amount of time during which the coupon is redeemable.

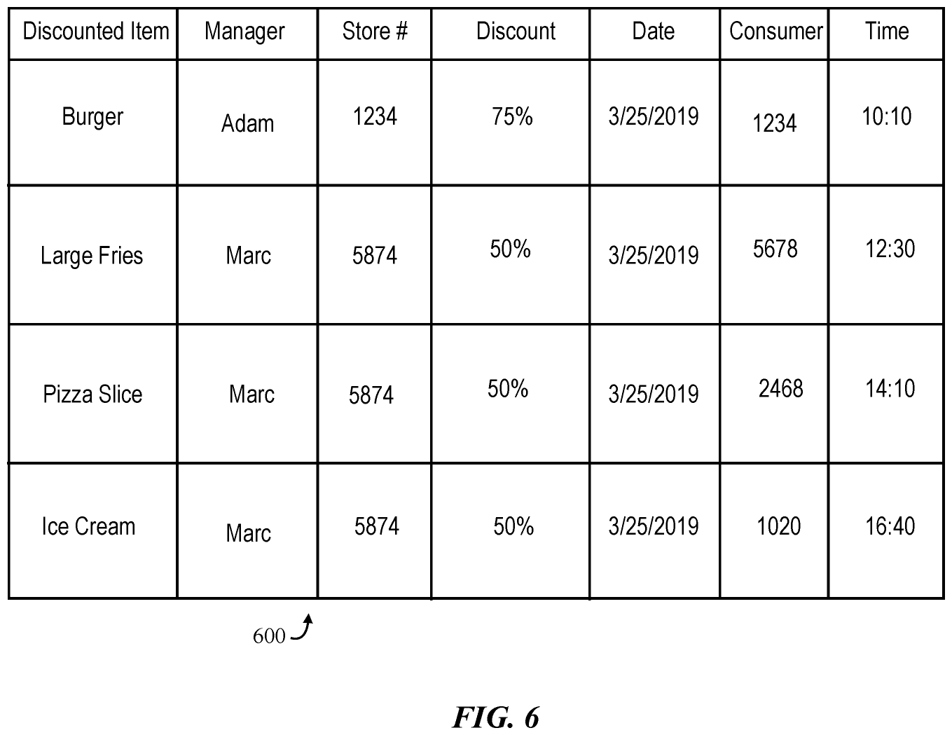

FIG. 6 illustrates a data interface 600 provided to the administrator to show data related to the electronic coupons. This may include the discounted item, provider (manager), store number or location, discount rate (shown as a percentage or as the difference between the original price of the discounted item and the amount after the discount is applied, a date and time when the electronic coupon was redeemed, and a consumer ID associated with the consumer who redeemed the electronic coupon. One skilled in the arts will readily understand that various other data metrics may be utilized.

In some embodiments, an ordering system is provided to the consumer. The ordering system permits the consumer to wirelessly transmit a request for a good or a service via the network and transmit a payment using a payment processing system. The ordering system may also apply the electronic coupon discount rate to the payment.

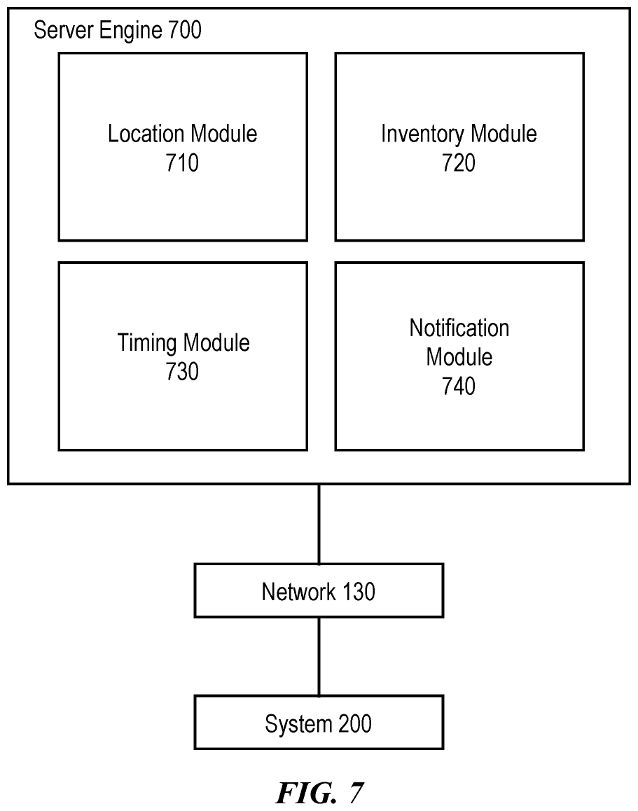

FIG. 7 illustrates a block diagram of the server engine 700 and associated modules in communication with the system 200 via network 130 to perform the various features provided herein. A location module 710 to permit the provider to select a geofenced region within which the electronic coupon is electronically transmitted. For example, the provider may select a geofenced region corresponding to the city of the restaurant managed by the provider. An inventory module 720 tracks inventory related to the plurality of items stored in the database. The inventory module 720 may utilize safe food handling and storage procedures to determine a best-by date or expiration date for each of the plurality of items. For example, the inventory module may determine that a seafood item is approaching its expiration date in two days. A notification may then be transmitted to the provider to alert the provider of the upcoming expiration date, and the creation of an electronic coupon may be suggested. A timing module 730 is operable to establish a time period within which the electronic coupon is valid and redeemable. For example, the provider may permit the redemption of the coupon at a location for one day at a predetermined discount rate. A notification module 740 generates notifications to the consumer, the provider, and the administrator. The notification may relate to the electronic coupon, the inventory of the plurality of items, and/or the location of the consumers and providers.

In some embodiment, the discount rate may be dynamic such that that discount rate changes during the time period selected by the provider. The discount rate may also change by the inventoried amount of items to promote the item to consumers and in turn reduce the amount of waste created.

In some embodiments, the system may provide a means for tracing the electronic coupon, such as via the use of a unique ID assigned to each electronic coupon. The unique ID may function to prevent fraud by tracking all transactions associated with each of the electronic coupons generated by the provider. The system may also issue a unique ID for each consumer or the point of sale (POS) systems thereof.

In some embodiments, the notification module may provide notifications for various tasks associated with food safety, operational safety, materials and data safety, and the like.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for managing a plurality of electronic coupons, the system comprising:
a provider in communication with a database, the database to store the plurality of electronic coupons corresponding to a plurality of items;
a location module to determine a location for one or more consumers, the location module utilizing a global positioning system of a computing device of the one or more consumers;
a server in operable communication with a network to transmit one or more of the plurality of electronic coupons from the database to the one or more consumers, wherein the one or more consumers are within a predefined location selected by the provider.

2. The system of claim 1, wherein each of the plurality of items is associated with one or more product names, a product date, and a product inventory.

3. The system of claim 1, wherein the location module permits the provider to select a geofenced region, and wherein the location module transmits, via the server, the one or more of the plurality of electronic coupons to consumers within the selected geofenced region.

4. The system of claim 1, further comprising a timing module to permit the provider to select a time duration for which the one or more of the plurality of coupons is valid.

5. The system of claim 1, wherein the provider selects a discount rate corresponding to the one or more product names.

6. A system for managing a plurality of electronic coupons, the system comprising:
a provider in communication with a database, the database to store the plurality of electronic coupons corresponding to a plurality of items;
a location module to determine a location for one or more consumers, the location module utilizing a global positioning system of a computing device of the one or more consumers;
a timing module to permit the provider to select a time period for the electronic coupon to be redeemed;
a server in operable communication with a network to transmit one or more of the plurality of electronic coupons from the database to the one or more consumers, wherein the one or more consumers are within a predefined location selected by the provider;
a notification module to generate a notification for the electronic coupon to be transmitted, via the server, to the consumer.

7. The system of claim 6, wherein the provider selects a discount rate for one of the plurality of items.

8. The system of claim 7, wherein the discount rate is a dynamic discount rate.

9. The system of claim 8, wherein the dynamic discount rate is generated by the timing module in operable communication with an inventory module configured to determine an inventory of the plurality of items.

10. The system of claim 6, wherein each of the plurality of items is associated with one or more product names, a product date, and a product inventory.

11. The system of claim 6, wherein the location module permits the provider to select a geofenced region, and wherein the location module transmits, via the server, the one or more of the plurality of electronic coupons to consumers within the selected geofenced region.

12. The system of claim 6, wherein an administrator interface provides a plurality of data to an administrator to permit the administrator to monitor provider data.

13. A system for managing a plurality of electronic coupons, the system comprising:
a provider in communication with a database, the database to store the plurality of electronic coupons corresponding to a plurality of items;
a location module to determine a location for one or more consumers, the location module utilizing a global positioning system of a computing device of the one or more consumers;
a timing module to permit the provider to select a time period for the electronic coupon to be redeemed;
a server in operable communication with a network to transmit one or more of the plurality of electronic coupons from the database to the one or more consumers, wherein the one or more consumers are within a predefined location selected by the provider;
a notification module to generate a notification for the electronic coupon to be transmitted, via the server, to the consumer;
an ordering system provided to the consumer, the ordering system permitting the consumer to wirelessly transmit a request for a good or a service via the network, the ordering system configured to apply the plurality of electronic coupons.

14. The system of claim 13, wherein the provider selects a discount rate for one of the plurality of items.

15. The system of claim 14, wherein the discount rate is a dynamic discount rate.

16. The system of claim 15, wherein the dynamic discount rate is generated by the timing module in operable communication with an inventory module configured to determine an inventory of the plurality of items.

17. The system of claim 13, wherein each of the plurality of items is associated with one or more product names, a product date, and a product inventory.

18. The system of claim 13, wherein the location module permits the provider to select a geofenced region, and wherein the location module transmits, via the server, the one or more of the plurality of electronic coupons to consumers within the selected geofenced region.

19. The system of claim 13, wherein an administrator interface provides a plurality of data to an administrator to permit the administrator to monitor provider data.

20. The system of claim 13, further comprising a payment processor to process a payment for the good or the service.
